(19) United States
(12) Patent Application Publication
(10) Pub. No.: US 2007/0127787 A1
(43) Pub. Date: Jun. 7, 2007

(54) Face recognition system and method

(76) Inventors: Kenneth R. Castleman, Friendswood, TX (US); Qiang Wu, Houston, TX (US); Samuel Cheng, Tulsa, OK (US); Le Zou, College Station, TX (US); Shalini Gupta, Austin, TX (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/585,402

(22) Filed: Oct. 23, 2006

Related U.S. Application Data
(60) Provisional application No. 60/730,125, filed on Oct. 24, 2005.

(51) Int. Cl. G06K 9/00

(52) U.S. Cl. 382/118

(57) ABSTRACT

A facial recognition system that captures a plurality two-dimensional images of a target face, creates a three-dimensional facial model from the plurality of two-dimensional images of a target face, moves the three-dimensional facial model to a predetermined pose orientation to result in a normalized three-dimensional facial model, extracts measurements from the normalized three-dimensional facial model, and compares the extracted measurements to other facial measurements stored in a data base. Measurement extraction can be enhanced by modifying the data format of the normalized three-dimensional facial model into range and color image data.

This application claims the benefit of U.S. Provisional Application No. 60/730,125, filed Oct. 24, 2005.

### GOVERNMENT GRANT

The development of the present invention was sponsored in part by Advanced Technology Program Cooperative Agreement Number 70NANB4H3022, “3-D FACE RECOGNITION FOR AIRPORT SECURITY SCREENING” from the National Institute of Standards and Technology, 100 Bureau Drive, Gaithersburg, Md. 20899.

### FIELD OF THE INVENTION

The present invention relates to automated face recognition, and more particularly to a system and method that captures and processes facial images for reliable personal identification of individuals for access control and security screening applications.

### BACKGROUND OF THE INVENTION

Face recognition systems and methods are known, but are not yet reliable enough for successful widespread application. The two most popular applications of face recognition systems today are access control to secure facilities and security screening.

Access control systems are used to authenticate the identity of individuals before allowing entry into a secure area. Specifically, the system stores images of personnel who are authorized to enter the secure area. When entry is attempted, the person's facial image is captured, and compared to facial images of authorized personnel. When a facial image match is detected, entry is granted. Access control systems generally can be made to operate more accurately than security screening systems, because the acquisition of facial images, both at the point and time of entry and for inclusion in the image data base (i.e. the enrollment process), is more controllable.

Security screening involves capturing images of people in public places and comparing them to images of persons who are known to pose security risks. One prime example of security screening is its use at airport security checkpoints. Obtaining high levels of accuracy in security screening is far more challenging than access control for several reasons. First, high quality facial image capture is more difficult because the environment in which images are captured (e.g. the chaos of an airport screening station) is uncontrolled. Second, the images available for use in the data base can be of very low quality. Instead of taking quality images of persons who have authorization to pass through the security station, security officials often have to resort to low quality pictures of suspects (e.g. mug shots, photographs taken in public, images from security cameras, etc.). This means that the system must accommodate variations in lighting, pose and other differences between the image captured and the stored images. Third, a security screening system must capture the image of the person, compare that image to the entire image data base, and flag possible security risks on a steady flow of people, and process each one in a matter of seconds. Finally, air travelers, as subjects, are generally less cooperative than would be employees reporting for work. This means they cannot be depended upon to present themselves as effectively to the system.

Many previous attempts at face recognition have performed well in controlled testing, but then failed miserably under actual screening conditions. The main problem has been a breakdown of accuracy when operating under actual screening conditions. Accuracy errors can be classified in terms of two parameters: miss rate (MR—the percentage of true positives that go undetected—i.e., are flagged as negative) and false alarm rate (FAR—the percentage of true negatives that are flagged as positive). If the processing parameters are adjusted to reduce the FAR, then MR will increase, and vice versa. There is a need for a face recognition system that works reliably in applications such as airport screening, where the system must deal with sources of error that occur during the image acquisition, image processing, image data storage, and image comparison steps of the operation.

### SUMMARY OF THE INVENTION

The present invention solves the aforementioned problems by providing a facial recognition system and method that more reliably acquires, processes and matches facial images.

A facial recognition system for analyzing images of a target face includes a facial model subsystem configured to create a three-dimensional facial model from a plurality of two-dimensional images of a target face, a normalization subsystem configured to move the three-dimensional facial model to a predetermined pose orientation to result in a normalized three-dimensional facial model, a measurement subsystem configured to extract measurements from the normalized three-dimensional facial model, and a matching subsystem configured to compare the extracted measurements to other facial measurements stored in a data base.

A facial recognition method for analyzing images of a target face includes creating a three-dimensional facial model from a plurality of two-dimensional images of a target face, moving the three-dimensional facial model to a predetermined pose orientation to result in a normalized three-dimensional facial model, extracting measurements from the normalized three-dimensional facial model, and comparing the extracted measurements to other facial measurements stored in a data base.

Other objects and features of the present invention will become apparent by a review of the specification, claims and appended figures.

### BRIEF DESCRIPTION OF THE DRAWINGS

FIG. 1 is a diagram of a facial recognition system.

FIG. 2 illustrates geometry and texture images of the target face captured via a multiple camera stereometry system.

FIG. 3 illustrates a 3-D mesh facial model of the target face.

FIG. 4 illustrates the 3-D mesh facial model of the target face and a generic facial model.

FIG. 5 illustrates the 3-D mesh facial model of the target face moved (translated and rotated) in spatial alignment with a generic facial model.

FIG. 6 is a diagram illustrating the normal distance d used to compare the target facial model mesh and the generic facial model mesh.

FIG. 7 is a diagram illustrating the geometric relationships when comparing the target facial model mesh and the generic facial model mesh using the normal distance d.

FIG. 8 is a front view of the generic facial model range image.

FIG. 9 is a perspective view of the mesh version of the generic facial model range image.

FIGS. 10A-10C are front, side and perspective views of an exemplary target facial model before normalization.

FIGS. 11A-11C are front, side and perspective views of the exemplary target facial model after normalization.

FIG. 12 is a perspective view of a color portrait produced by projecting the RGB texture values from a target facial model onto the X-Y plane.

FIGS. 13A and 13B are perspective and front views of a range image.

FIG. 14 illustrates front views of the color portrait and the range image.

FIG. 15 illustrates the data structure of the color portrait and the range image.

FIGS. 16A-16D are front views of the unwarped generic facial model, the unwarped generic facial model with a control grid, the warped generic facial model with modified control grid, and the warped generic facial model without control grid, respectively.

FIG. 17 illustrates a 2-dimensional feature space where an unknown face is mapped to a position that does not overlap any of the ellipsoids that represent stored faces in a data base.

### DETAILED DESCRIPTION OF THE PREFERRED EMBODIMENTS

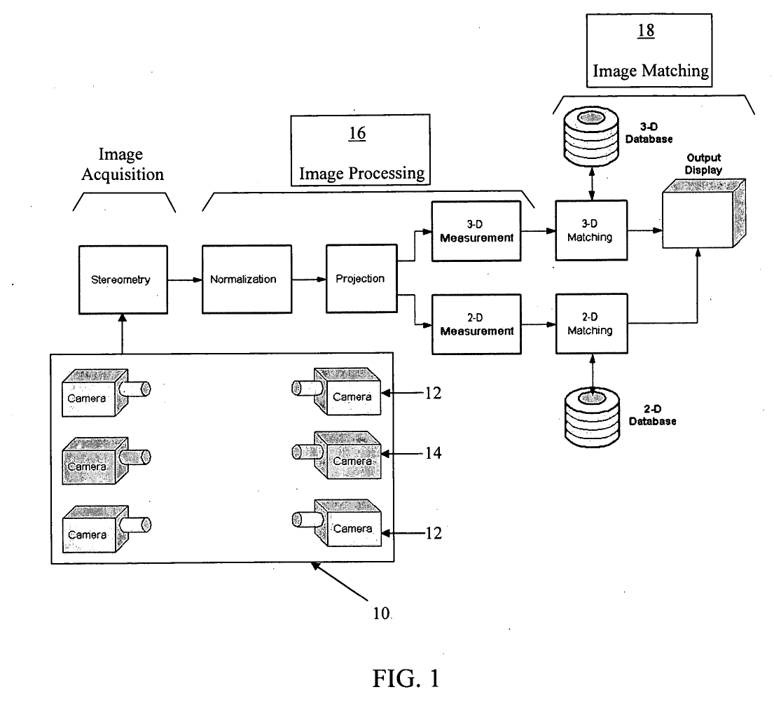

The present invention is a face recognition system and method that reflects an end-to-end optimization of the entire process of facial image acquisition, processing and comparison to ensure optimum performance. It uses three-dimensional (3-D) image analysis to measure and quantify the unique geometric and photometric characteristics of a person's face so that his or her identity can be verified. The methodology of face recognition according to the present invention can be broken down into 1) image acquisition, 2) image processing, and 3) image matching, as illustrated in FIG. 1.

1. Image acquisition

There are two image acquisition steps involved in the present invention: 1) image acquisition for storage in a data base (also referred to as enrollment), and 2) image acquisition for comparison with stored images that are in the data base (also referred to as security or access control image acquisition). From these images, a 3-D model of the face can be generated. Various techniques can be employed for either image acquisition step, so long as at least two,different images of the face, taken from different angles, are provided so that three dimensional geometric measurements of the face (optionally along with color information) can be extracted from the images produced by the image acquisition technique used.

Multiple camera stereometry is a well known technique that utilizes a plurality of cameras that, in combination, can be used for 3-D image acquisition. 3-D imaging overcomes the traditional problems of lighting and pose variations that have prevented 2-D face recognition from being successful in practice. An example of multiple camera stereometry is a camera system 10 that includes the combination of monochrome and color cameras used to capture geometry and texture images of the same face, as illustrated in FIG. 1. Monochrome cameras 12, operating with a textured flash projector, are used to capture 2-D images that can be used to produce a 3-D geometric model of the face. Color cameras 14, operating with white flashes, are used to capture the color and texture information of the face. As a non-limiting example, one or more flash projectors illuminate the face with a random texture pattern, while two or more monochrome cameras 12 record “geometry” images of the face from different angles. Subsequently, one or more white flashes illuminate the face for one or more RGB color cameras 14 to record “texture” images of the face. The geometry and texture image acquisitions are staggered in time, with the whole process taking as little as 2 ms., to eliminate the possibility of significant subject movement between images. The controlled illumination supplied by the white flashes allows, with proper calibration, for the computation of hue, saturation, and intensity at each pixel in the texture images. Since these are surface properties of the face (not photometric properties of the camera system), they can lead to skin color features that are useful for identification. The number of cameras may vary depending upon the application. A three camera image acquisition technique (two geometry cameras 12 and one texture camera 14) is useful for access control and for enrolling images into the data base, given the more controlled setting. A six camera image acquisition technique (four geometry cameras 12 and two texture cameras 14 as illustrated in FIG. 1) is ideal for acquiring images in a security screening setting, given the more chaotic setting.

While multiple camera stereometry is a preferred technique for capturing facial images, it is possible to utilize other facial images (e.g. photographs, mug shots, etc.), so long as there are at least two images from two different angles for the same face, so that the three dimensional model of the face can be prepared as described below. Further, there are other techniques for generating a three dimensional model of the face, such as laser scanners and structured illumination systems (i.e. systems that use a single camera and a projection of a known pattern onto the target face to reconstruct the 3-D geometry of the target face). In fact, even photographs can be used to create a three-dimensional model of the target face (e.g. take a generic model of the human head and warp it so that the photographic images will project onto the warped head without error, where the warped head can be used as a geometric model of the target face).

2. Image Processing

Once the multiple images of the target face have been acquired by the camera system, a computer system 16 (e.g. a processor running software) is preferably used to process the images to create image data ideal for image matching. Ideally, there are five image processing steps: a) construction of a 3-D facial model of the target face (hereinafter “target facial model”), b) normalization of the target facial model to create a very useful portrait image, c) projection of the target facial model to form an X-Y range image, d) quantitative facial geometry and color measurements taken from the portrait and range images, and e) facial image matching. The data resulting from this image processing enables a much faster and more reliable comparison with stored data for image matching by a computer system 18 (which may be the same as, a component of, networked to, or completely separate from, computer system 16).

a. 3-D Model Construction

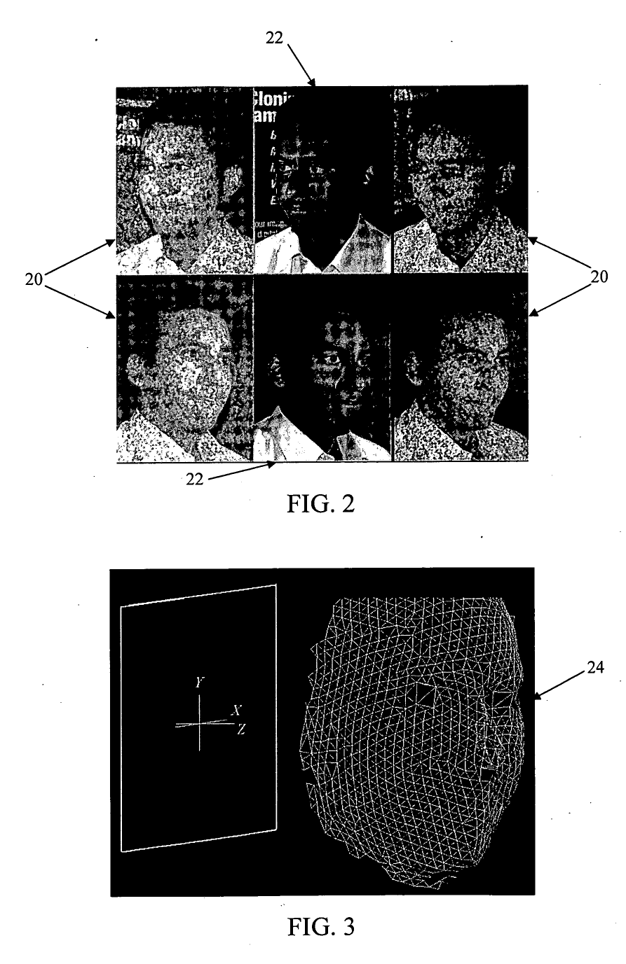

The computer system 16 generates the target facial model (a texture-mapped facial 3-D polyhedral mesh) of the target face using well known techniques. Specifically, FIG. 2 illustrates 6 images generated using the 6-camera system 10 of FIG. 1: four geometry images 20 (showing the textured pattern projected onto the target face during acquisition) and two texture images 22 (showing the coloring of the imaged target face). From these images 20,22, the target facial model 24 (a texture-mapped 3-D mesh model of the target face) can be generated (as illustrated in FIG. 3) using well known techniques. For example, well known algorithms and techniques can be used to calibrate the multiple camera system (so that the position and the orientation of each camera is known), such as those described in R. Y. Tsai, “A Versatile Camera Calibration Technique for High-Accuracy 3D Machine Vision Metrology Using Off-the-Shelf TV Cameras and Lenses,” IEEE J Rob. & Auto, RA-3(4):323-344, 1987 (which is incorporated herein by reference). Well known algorithms and techniques can then be used to match two or more geometry images to find x,y,z points on the surface of the target face shown in those images, such as those described in A. W. Gruen, “Least Squares Matching,” in K. Atkinson, ed., Close Range Photogrammetry and Machine Vision, 1987 (which is incorporated herein by reference). Well known algorithms and techniques can also be utilized to conduct efficient computations on stereo image data, such as those described in G. P. Otto and T. K. W. Chau, “Region Growing algorithm for matching of terrain images,” Image and Vision Computing, 7(2):83-94, 1989 (which is incorporated herein by reference). These and similar techniques are well known in the field of stereometry and have been used extensively for creating three-dimensional geometric models of objects (terrain, etc.) that have been imaged by two-dimensional cameras in multiple locations. Because stereometric techniques are well known in the art, and example techniques are presented in the three references cited above, it will not be further discussed herein.

b. Normalization

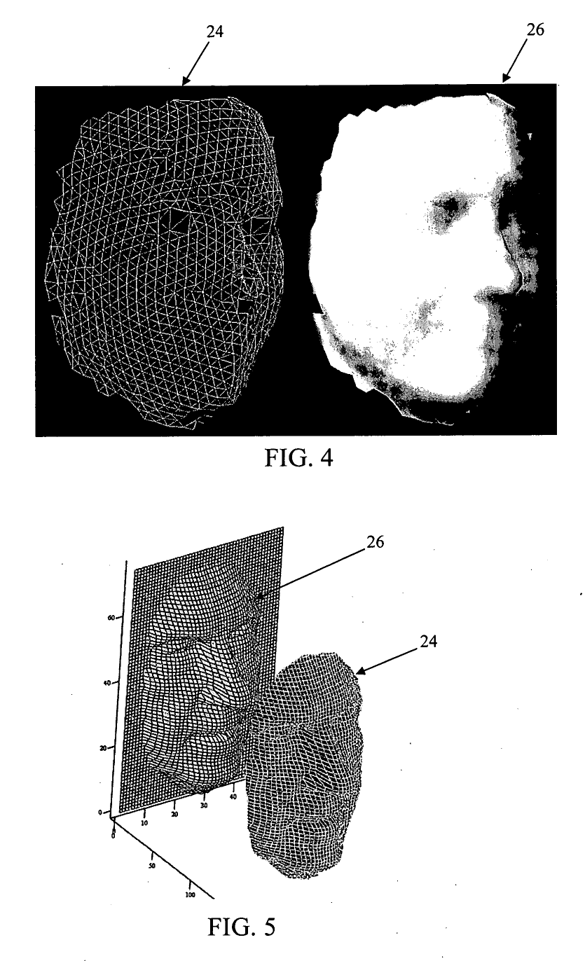

One problem with conventional 2-D facial recognition techniques is that comparing facial images having different poses (angles relative to the camera) increases the error rates. Therefore, according to the present invention, this pose problem is solved by a normalization step that orients each target facial model against a generic facial model located at a standard position (pose) in 3-space. More specifically, as illustrated in FIG. 4, the target facial model 24 is moved (translated, scaled and/or rotated) in space to align it with a generic facial model 26 of known and standard position (pose) orientation. Thus, all facial models in the data base, and all facial models created for comparison to the stored facial models in the data base, are ail oriented at the same standard pose orientation relative to a common three-dimensional coordinate system. The concept of bringing each incoming target facial model into a standard position in space by aligning it with the generic facial model is an important innovation. This makes the subsequent processing both simpler and more accurate.

A mean-square-difference minimization technique is preferably used to quantify the positional error (difference between the two facial models) during the normalization process. The target facial model 24 is moved (translated, scaled and/or rotated) until it best matches the generic facial model 26 (i.e. minimizes the mean square distance between the two facial models). Scaling of the generic facial model 26 in three dimensions is allowed during the orientation process, and the three scale factors that result in the best match are potentially useful features for identification. Specifically, each target facial model 24 is oriented against a generic facial model that is located at a standard position in 3-space, as illustrated in FIG. 5. Ideally, the tip of the nose is positioned at the origin of 3-space, with the pupils lying on a line that is parallel to the X-axis, and the forehead of the face is angled about 10 degrees backward, relative to the X-Y plane. This particular orientation permits generation of a range image in which Z is most commonly a single-valued function of X and Y.

With regard to calculating the mean square error (MSE), one approach is to consider directly the distance between each vertex of the target facial model 24 and the nearest vertex on the generic facial model 26. This approach, however, has two disadvantages:

1. The computed MSE can become a very inaccurate overestimate when the facial model mesh is coarse.

2. The MSE calculation can be computationally intense since, for each vertex on the target facial model 24, searching must be performed over every vertex on the generic facial model 26, and since the vertices ordinarily are not well ordered in the data file.

Therefore, instead of using the generic facial model 26 mesh directly, it is preferable to “reformat” that geometrical representation of the generic face into a digital range image representation that uses triples (x[m],y[n],z[m,n]), m=0,1,2, . . . ,500 and n=0,1,2, . . . ,750. Range images are well known in the 3-D image processing art (e.g., K. R. Castleman, Digital Image Processing, Prentice-Hall, 1996, Chapter 21, which is incorporated herein by reference). In a particular example, the range image is a 750 row by 500 column monochrome digital image wherein m is the column number and n is the row number. The column and row addresses, m and n, are related to the 3-D coordinate system of the generic facial model as follows. The origin of the 3-D space is located at the center of the image, i.e., at m=250, n=375. Other values of m are equally spaced in x, while other values of n are equally spaced in y. If the pixel spacing is, for example, 0.32 mm per pixel, then x[m]=0.32[m−250] and y[n]=0.32[n−375], in millimeters. Thus x and y are linearly related to m and n, respectively. The gray level at pixel (m,n) is linearly related to z, i.e., z=0.32z[m,n], where z[m,n] is the gray level value of the pixel at column m, row n, and the scale factor is, again, 0.32 mm per gray level.

Points on the generic face at arbitrary (x,y,z) locations can then be obtained by interpolation (e.g., bilinear interpolation) of the range image. That is, for any point (x,y), the range value Z(x,y) is approximated as:

$$Z ( x , y ) = \frac{x [ m + 1 ] - x}{x [ m + 1 ] - x [ m ]} \frac{y [ n + 1 ] - y}{y [ n + 1 ] - y [ n ]} z [ m , n ] + \frac{x [ m + 1 ] - x}{x [ m + 1 ] - x [ m ]} \frac{y [ n + 1 ] - y}{y [ n + 1 ] - y [ n ]} z [ m , + 1 , n ] + \frac{x [ m + 1 ] - x}{x [ m + 1 ] - x [ m ]} \frac{y - y [ n ]}{y [ n + 1 ] - y [ n ]} z [ m , n + 1 ] + \frac{x - x [ m ]}{x [ m + 1 ] - x [ m ]} \frac{y - y [ n ]}{y [ n + 1 ] - y [ n ]} z [ m + 1 , n + 1 ] , \qquad ( 1 )$$

where xε[x[m],x[m+1]] and yε[y[n],y[n+1]].

A first algorithm to approximate MSE using the range fuiction is:
Set MSE=0;
For each vertex (x,y,z) on the unknown face mesh
   MSE=MSE+(Z(x,y)−z)²
End For

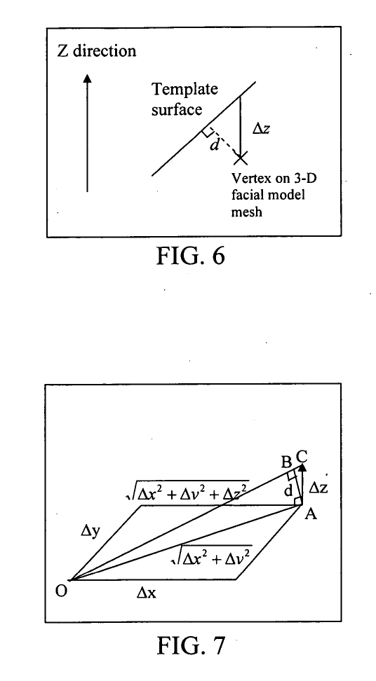

(where MSE=MSE/Total# vertices on the unknown face mesh.)
This first algorithm calculates the average squared distance, along the z-direction, between a vertex on the target facial model mesh and the generic facial model surface. This gives a good approximation when the generic face surface is flat (i.e.,. with a small gradient). However, when the slope is large, a better approach is to use the normal distance d (instead of Δz—the distance in the z-direction), as illustrated in FIG. 6. Then, as evidenced from the geometric relationship between d and x,y shown in FIG. 7, it is evident that:

$$d = Δ z ( \frac{Δ {x}^{2} + Δ {y}^{2}}{Δ {x}^{2} + Δ {y}^{2} + Δ {z}^{2}} ) \qquad ( 2 )$$

since the triangle OAC and the triangle ABC are similar. The value d can then be expressed as:

$$∴ d = ( \frac{{( \frac{Δ x}{Δ z} )}^{2} + {( \frac{Δ y}{Δ z} )}^{2}}{{( \frac{Δ x}{Δ z} )}^{2} + {( \frac{Δ y}{Δ z} )}^{2} + 1} ) Δ z = λ Δ z , \qquad ( 3 )$$

where Δx/Δz at any arbitrary lattice point (x[m],y[n]) of the template, for instance, can be approximated as:

$$\frac{Δ x}{Δ z} {\vert}_{x = x [ m ] , y = y [ n ]} = \frac{x [ m + 1 ] - x [ m ]}{z [ n + 1 ] - z [ n ]} . \qquad ( 4 )$$

Δy/Δz can be approximated in a similar manner. Since λ only depends on the template, it can be pre-computed and stored. For inter-lattice-point values of λ, bilinear interpolation can be used, just as in the case of the range image. Thus, a second algorithm to approximate MSE using the range function is:
Set MSE=0;
For each vertex (x,y,z) on the unknown face mesh
   MSE=MSE+λ(x,y)(Z(x,y)−z)²
End For

### DETAILED NORMALIZATION EXAMPLE

The following is a more detailed example of normalization calculations in which the randomly oriented target facial model is oriented into a standard position by aligning it with a generic facial model of standard orientation.

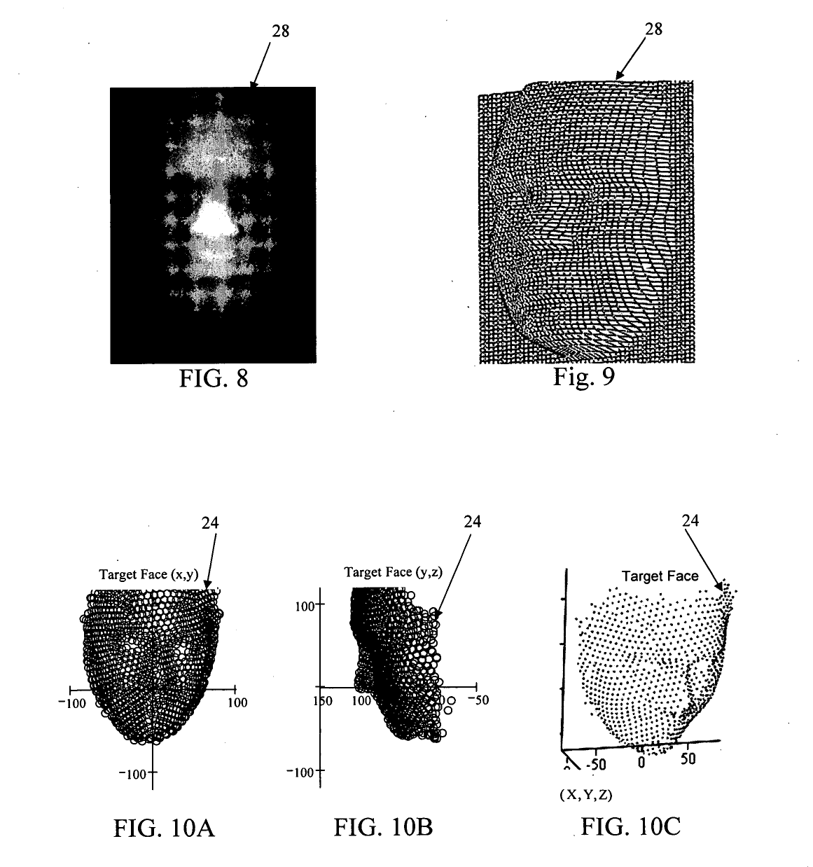

The process begins with a generic facial model range image 28 as illustrated in FIGS. 8 and 9. The range image, in this example, is 201 columns by 301 rows. Its origin is located at column 101, row 151, and it has a pixel spacing of 0.8 mm in x & y, and 0.32 mm in z. It covers a volume of −80<x<80, −120<y<120 and −82<z<0. The generic face z-value noninteger [x,y] is given by:

$$Zg ( x , y ) := if [ \vert x \vert > 79 , 0 , if [ \vert y \vert > 119 , 0 , Δ z \cdot ( Bilin ( G , \frac{x}{Δ x} + {x}_{0} , {y}_{0} - \frac{y}{Δ x} ) - 255 ) ] ] \qquad ( 5 )$$

where Bilin(G,x,y) performs a bilinear interpolation as described further below.

The target facial model is then read, where the target face is represented by a point cloud of [x,y,z] values. The ith row of an NP row by NC column matrix [T] has the form [xᵢ, yᵢ, zᵢ, 1]. For this example, NC can be 4, and NP can be 916, and i=0 . . . (NP−1). The display of the exemplary target face is illustrated in FIGS. 10A-10C.

The translation, scaling and rotation of the target facial model are implemented by homogeneous coordinates. The transformation matrices are:

$$Tr ( {X}_{0} , {Y}_{0} , {Z}_{0} ) ≡ ( \begin{matrix}1 & 0 & 0 & 0 \\ 0 & 1 & 0 & 0 \\ 0 & 0 & 1 & 0 \\ - {X}_{0} & - {Y}_{0} & - {Z}_{0} & 1\end{matrix} )$$

$$S ( Sx , Sy , Sz ) ≡ ( \begin{matrix}Sx & 0 & 0 & 0 \\ 0 & Sy & 0 & 0 \\ 0 & 0 & Sz & 0 \\ 0 & 0 & 0 & 1\end{matrix} )$$

$$Rx ( θ x ) ≡ ( \begin{matrix}1 & 0 & 0 & 0 \\ 0 & cos ( θ x ) & - sin ( θ x ) & 0 \\ 0 & sin ( θ x ) & cos ( θ x ) & 0 \\ 0 & 0 & 0 & 1\end{matrix} )$$

$$Ry ( θ y ) ≡ ( \begin{matrix}cos ( θ y ) & 0 & sin ( θ y ) & 0 \\ 0 & 1 & 0 & 0 \\ - sin ( θ y ) & 0 & cos ( θ y ) & 0 \\ 0 & 0 & 0 & 1\end{matrix} )$$

$$Rz ( θ z ) ≡ ( \begin{matrix}cos ( θ z ) & - sin ( θ z ) & 0 & 0 \\ sin ( θ z ) & cos ( θ z ) & 0 & 0 \\ 0 & 0 & 1 & 0 \\ 0 & 0 & 0 & 1\end{matrix} )$$

The RMS distance between the generic face and the target face is measured parallel to the z-axis as:

$$RMSD ( X , Y , Z ) := \sqrt{\frac{1}{NP} \cdot {\sum }_{i} {if ( Zg ( {X}_{i} , {Y}_{i} ) < - 80 , 0 , {Z}_{i} - Zg ( {X}_{i} , {Y}_{i} ) )}^{2}}$$

For the exemplary target face, D₀=RMSD(X,Y,Z)=94.123. The tip of the nose should be at the origin, this face is about 100 mm too far forward (in the z-direction), as well as being tilted too far forward. To implement the translation/scaling/rotation, the derivatives due to the translation in each direction are calculated:
Q=T·Tr(1,0,0) X=Q^{<0>} Y=Q^{<1>} Z=Q^{<2>} dzₓ=RMSD(X,Y,Z)−D₀ dzₓ=−0.059
Q=T·Tr(0,1,0) X=Q^{<0>} Y=Q^{<1>} Z=Q^{<2>} dz_{y}=RMSD(X,Y,Z)−D₀ dzₓ=−0.199
Q=T·Tr(0,0,1) X=Q^{<0>} Y=Q^{<1>} Z=Q^{<2>} dz_{z}=RMSD(X,Y,Z)−D₀ dzₓ=−0.846
Using Newton's method to calculate the step size:
dz:=\sqrt{dzₓ²+dz_{y}²+dz_{z}²}
dz=0.871. Thus, D₀/dz=108.051. Taking a step size k in the direction of steepest descent (k=108):
Q=T·Tr(−k·dzₓ, −k·dz_{y}, −k·dz_{z},) X=Q^{<0>} Y=Q^{<1>} Z=Q^{<2>} RMSD(X,Y,Z)=28.765
The process repeats until it converges. Transformation parameters that minimize the RMS distance are found by iteration. They are:

$$( \begin{matrix}{X}_{0} \\ {Y}_{0} \\ {Z}_{0}\end{matrix} ) := ( \begin{matrix}10 \\ - 1 \\ 107\end{matrix} )$$

$$( \begin{matrix}Sx \\ Sy \\ Sz\end{matrix} ) := ( \begin{matrix}82 \\ 86 \\ 69\end{matrix} ) \cdot \%$$

$$( \begin{matrix}θ x \\ θ y \\ θ z\end{matrix} ) := ( \begin{matrix}20.5 \\ 9.9 \\ - 3.7\end{matrix} ) \cdot deg$$

The entire transformation can be implemented as a single matrix multiplication:
M:=Tr(X₀,Y₀,Z₀)·Rz(θz)·Ry(θy)·Rx(θx)·S(Sx,Sy,Sz)
with Q=T·M, X=Q^{<0>}, Y=Q^{<1>}, Z=Q^{<2>}. The RMS distance after the optimal transformation: RMSD(X,Y,Z)=4.8.

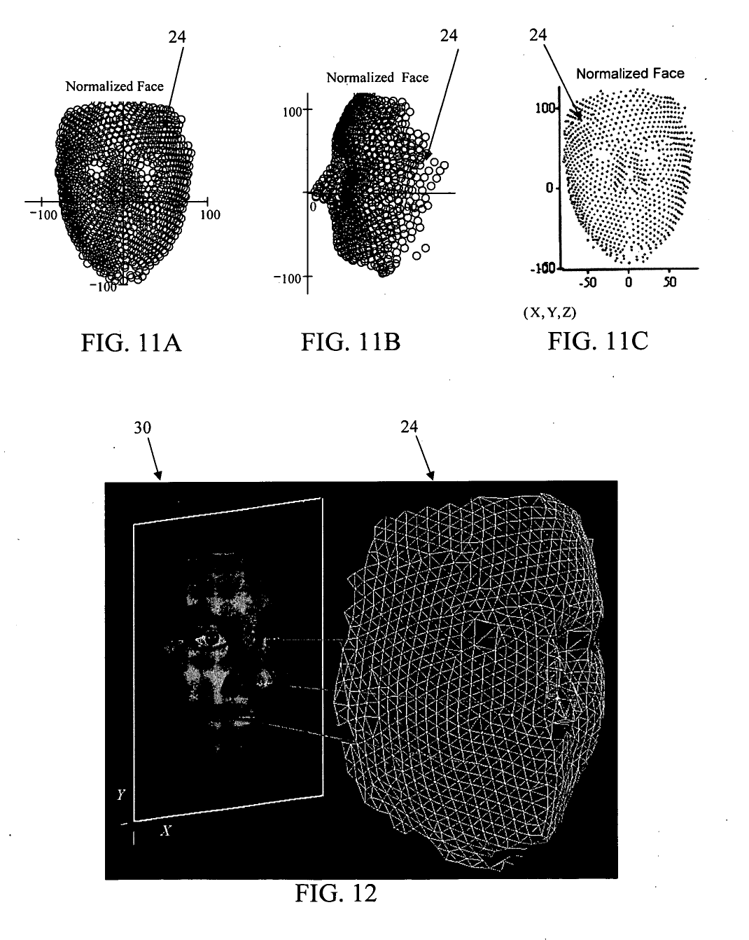

The translation and rotation values determined by the optimization process are used to normalize the target face. The scale values are used as features for classification, but are not used to actually scale the target face. The result is a target face, properly oriented and ready to be converted to range image form and measured, as illustrated in FIGS. 11A-11C.

RMS distance was minimized by adjusting the transformation parameters in the following order: translation, scale, rotation. The intermediate RMS distance values obtained for the first iteration are shown below:

$$( \begin{matrix}{X}_{0} \\ {Y}_{0} \\ {Z}_{0} \\ Sx \\ Sy \\ Sz \\ θ x \\ θ y \\ θ z \\ RMSD\end{matrix} ) = ( \begin{matrix}0 \\ 0 \\ 0 \\ 1.0 \\ 1.0 \\ 1.0 \\ 0 \\ 0 \\ 0 \\ 94.123\end{matrix} )$$

$$Initial \\ ( \begin{matrix}{X}_{0} \\ {Y}_{0} \\ {Z}_{0} \\ Sx \\ Sy \\ Sz \\ θ x \\ θ y \\ θ z \\ RMSD\end{matrix} ) = ( \begin{matrix}10 \\ 2 \\ 109 \\ 1 \\ 1 \\ 1 \\ 0 \\ 0 \\ 0 \\ 32.505\end{matrix} )$$

$$Translation \\ ( \begin{matrix}{X}_{0} \\ {Y}_{0} \\ {Z}_{0} \\ Sx \\ Sy \\ Sz \\ θ x \\ θ y \\ θ z \\ RMSD\end{matrix} ) = ( \begin{matrix}10 \\ 2 \\ 109 \\ 0.82 \\ 0.85 \\ 0.69 \\ 0 \\ 0 \\ 0 \\ 19.187\end{matrix} )$$

$$Scaling \\ ( \begin{matrix}{X}_{0} \\ {Y}_{0} \\ {Z}_{0} \\ Sx \\ Sy \\ Sz \\ θ x \\ θ y \\ θ z \\ RMSD\end{matrix} ) = ( \begin{matrix}10 \\ - 1 \\ 107 \\ 0.82 \\ 0.86 \\ 0.69 \\ 20.5 \\ 9.9 \\ - 3.7 \\ 4.800\end{matrix} )$$

$$Final$$

The final step in normalization is rotating and translating the target face by the parameters found above. The target face is not scaled. Instead the three scale parameters serve as valuable measurements of the face.

Regarding bilinear interpolation, it is used to compute z-values from the range image with subpixel accuracy, where x and y are fractional column and row indices, respectively, into the array [A]. Thus, x is positive to the right; and y is positive down.

$$Bilin ( A , x , y ) ≡ ( \vert \begin{matrix}ix ← floor ( x ) \\ dx ← x - ix \\ iy ← floor ( y ) \\ dy ← y - iy \\ d ← {A}_{iy , ix} \\ a ← {A}_{iy , ix + 1} - d \\ b ← {A}_{iy + 1 , ix} - d \\ c ← {A}_{iy + 1 , ix + 1} + d - {A}_{iy + 1 , ix} - {A}_{iy , ix + 1} \\ a \cdot dx + b \cdot dy + c \cdot dx \cdot dy + d\end{matrix} )$$

In this program, ix and iy are the integer parts of x and y, respectively, and dx and dy are the fractional parts. For example:

$$:= ( \begin{matrix}2 & 3 & 4 & 5 & 6 \\ 3 & 4 & 5 & 6 & 7 \\ 4 & 5 & 8 & 7 & 5 \\ 5 & 6 & 7 & 4 & 3 \\ 5 & 4 & 3 & 2 & 1\end{matrix} ) ( \begin{matrix}x \\ y\end{matrix} ) := ( \begin{matrix}2.7 \\ 1.3\end{matrix} ) Bilin ( A , x , y ) = 6.18$$

The origin of the matrix [0,0] is the upper left element.

c. Projection (range and color portrait images)

Once the target facial model 24 has been oriented via normalization, the normalized target facial model 24 can be represented as color portrait and/or range image data, which fully characterize the 3-D model information contained in the target facial model 24. In this manner, the target facial model 24 can be analyzed more efficiently because the color portrait and/or range image data is easier to operate on than the 3-D mesh data used to represent the target facial model 24.

The color portrait 30 is produced by taking the RGB texture values that map onto the target facial model 24, and orthographically projecting them onto the X-Y plane, which results in a perfectly aligned “head-on” color portrait 30 in which the subject is posed in a rigidly standard (i.e. “mugshot”) format (see FIG. 12). Orthographic projection does not usually produce a very flattering portrait. The normal foreshortening is absent, and the ears often appear too large. But, the color portrait image does include all of the color information for the target face, and it contains the color information about the face in a convenient, compact format.

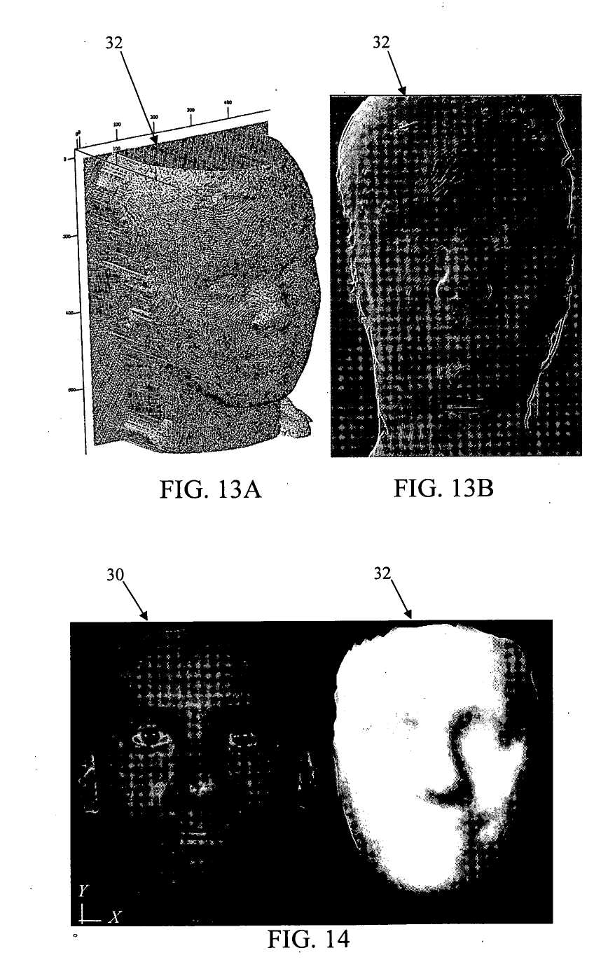

A range image 32 is produced by computing (for each pixel) the distance from the target facial model surface to the X-Y plane (along the Z-axis), as illustrated in FIGS. 13A-13B. Since the generic model is tilted slightly upward, the areas under the nose and chin are visible, and it is unlikely that any range values will be a multi-valued function of (X,Y). In cases where it is, the largest value of Z is used. For an 8-bit range image, the maximum gray level is 255. With a z-axis scale factor of 0.32 mm per gray level, as in the example shown in FIG. 13B, this corresponds to a Z value of 82 mm. Thus, points falling more than 82 mm behind the tip of the nose are discarded. The range image can be conveniently scaled so that a gray level of 255 corresponds to the tip of the nose, and zero corresponds to a plane 82 mm behind the tip of the nose. In the range image, Z is a function of X and Y. Assuming that Z(X,Y) is single-valued, this representation includes all of the information present in the 3-D target face model mesh 24, but is in a much more compact and better organized format for data access. The range image data then can be processed with standard 2-D image processing software and algorithms.

Thus, from the normalized textured target face model mesh 24, two images are generated (see FIG. 14): 1) the range image 32 (which has a value z for each x,y position-z(x,y)), and 2) the color portrait 30 (which as red, green, blue color values for each x,y position—RGB(x,y)). Taken together, these two 2-D images 30, 32 completely characterize the 3-D model of the normalized target face model 24. Specifically, the color portrait 30 completely describes the coloring of the target face, and the range image 32 completely describes the 3-D geometric shape of the target face. This is equivalent to a four-valued (R, G, B, Z) function of X and Y (where X and Y are organized on a rectangular sampling grid), and it is a much more compact and more easily processed representation (much more accessible data structure) than the polyhedral 3-D mesh (unordered sets of [X, Y, Z, R, G, B] sextuplets). With this data configuration, the major landmarks of the face are now located at very predictable pixel coordinates. Cross-correlation with landmark templates (e.g., a circular pupil model, etc.) will locate their exact position to subpixel accuracy. Subsequent feature extraction can now be done primarily from the portrait and range images, where standard 2-D image processing algorithms and software can be used. This data structure greatly enhances processing and image matching speed and accuracy.

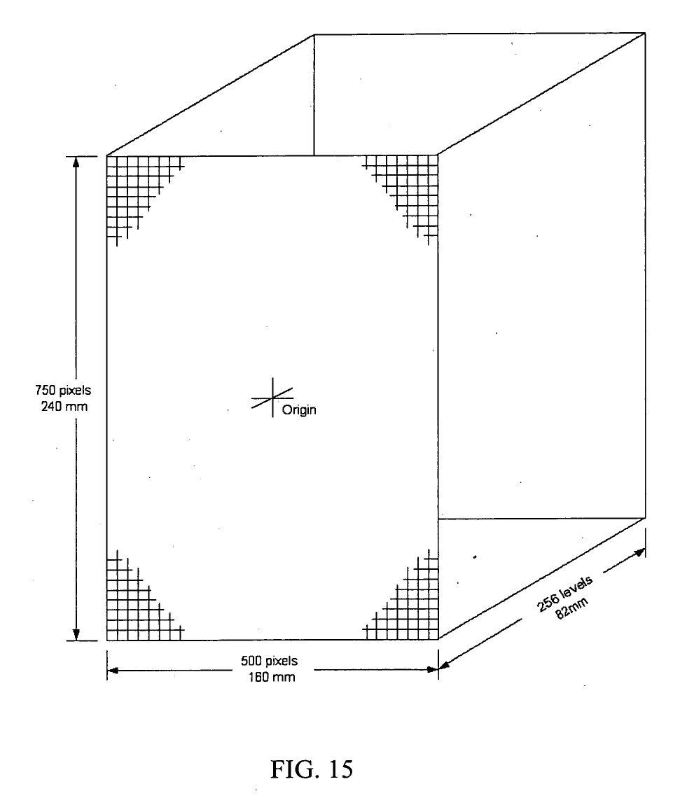

As a non-limiting example, the portrait can be stored as a 24-bit RGB bitmap image, and the range image can be stored as an 8-bit monochrome bitmap image. Lossy compression (e.g., JPEG) should be avoided as it would alter the pixel values. Both images are 751 rows by 501 columns. With row and column numbering beginning at zero, the origin of 3-D space is located at row 375, column 250 in both images. The pixel spacing can be 0.32 mm in X Y, and Z. The “box” in 3-D space containing the face is then conveniently 160 mm (500 pixels) wide, 240 mm (750 pixels) tall, and 82 mm (256 gray levels) deep. The tip of the nose is at the origin, with eight bits of R, G, B and range data. An example of the data structure of these two images is illustrated in FIG. 15.

d. Measurements

Once the portrait and range images 30, 32 have been derived, measurements are made using the data from these images to derive quantitative features that describe unique characteristics of a face. For example, facial landmarks (e.g., pupils, corners of eyes, etc.) are located in the portrait and range images 30,32, and their positions are measured. Photometric measurements (e.g., average hue of the forehead, etc.) are extracted from the portrait image 30. Geometric measurements (e.g., curvatures, geodesic distances, etc,) are extracted from the range image 32. It is these measurements that are used to derive quantitative features that describe unique characteristics of a face. These features can fall into three categories: model-based, geometric-based, and wavelet-based.

Model-Eased Features

As described above, a deformable generic face model can be used for normalization (orientation and cropping) and segmentation of target facial models. The deformable generic face model can also be used to produce feature measurements. Specifically, the generic face can be controlled by approximately 40 parameters that allow it to deform to match any other face. If each facial model is first oriented and cropped to match the (scaled) generic face, and the generic face is then deformed by adjustment of its parameters to minimize the mean square difference between the two, the deformation parameters of the generic face can serve as candidate features for identification. This process is described below.

The deformable generic face, to which all other facial models are aligned using the iterative closest point algorithm, is pre-segmented into regions (“components”) that correspond to eyes, nose, mouth, cheek, forehead, etc. Key features are also marked on the generic face model. Then, the facial model is segmented into components using the segmentation boundaries existing on the generic face. Thus, features and regions on the individual facial models are delineated accurately in the process. This intrinsic face segmentation technique is both faster and more robust than the automatic methods that have been used in the past.

Each facial component can be assigned a “reliability factor” that weighs its importance in the subsequent analysis. For example, a chin obscured by a beard would receive a lower reliability factor than a bare chin. Controlled illumination and calibrated color images of the facial models allows for computation of the average hue and saturation of each component. These color features are useful not only in facial matching, but in eliminating anything that is not a living human face.

Facial model deformation is also called morphing or warping, and a specific non-limiting example thereof is described in more detail where a morphable facial model is used to derive facial geometry features. A generic face is warped by a geometric operation to conform to the target face. The warp is specified by the x,y displacement of landmarks on the generic face. These displacements are iterated to minimize the mean square difference between the generic face and the target. The final values of the displacements then become geometric features of the target face.

A geometric operation is basically a copying operation wherein the pixels are moved around. The operation is typically specified by a set of “control points” in the input image and a corresponding set of control points in the output image. Each input control point maps to the corresponding output control point. Collectively, the set of control points in each image defines a “control grid.” Pixels that fall between control points (as most pixels do) are displaced by an amount interpolated from the control point displacements.

It is customary to implement a geometric operation so that the output grid is rectangular, and the input grid is free-form. The warp is then specified by the x,y displacement of the output points (i.e. how far does each output control point have to move to find its corresponding input control point). However, with facial recognition, a warp is used wherein the movement of landmarks in the generic (input) image is specified (i.e. how far does each landmark (input control point) move to form the morphed (output) image). This is thus an inverse problem.

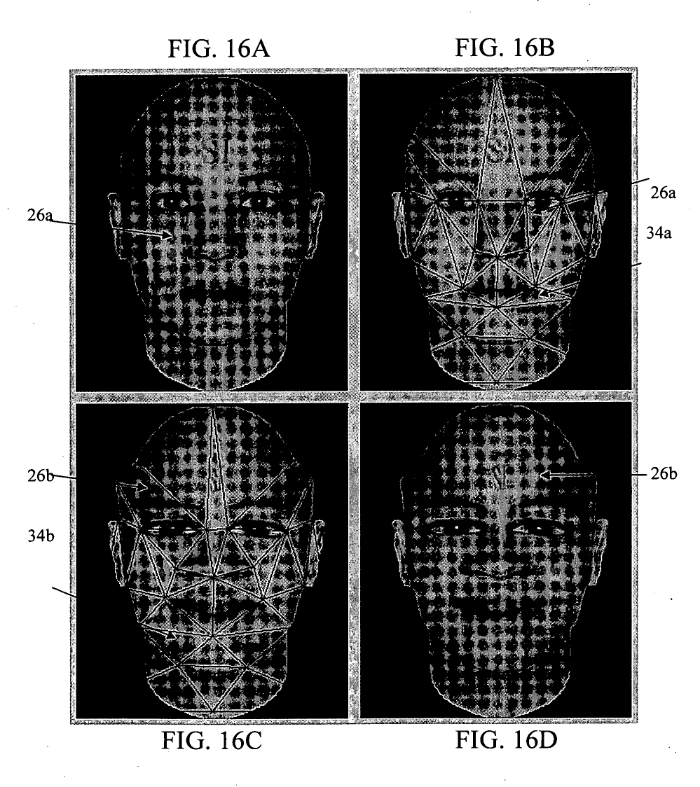

For example, FIG. 16A shows a generic facial model 26a in its unwarped form. FIG. 16B shows an overlay of the input control grid 34a. Each vertex of the control grid serves as a control point. The control points are strategically placed around the border of the image and at specific landmarks on the face (e.g. corners of the eyes and mouth, tip and sides of nose, etc.). FIGS. 16C (with modified input control grid 34b) and 16D (without modified input control grid 34b) show the output (warped) model 26b, with the control points of the 30 control grid 34b moved to match the target face. In operation, both the generic face and the target face exist as registered image pairs consisting of an orthographic portrait and a range image. The control points on the generic range image are iteratively moved in x and y to minimize the mean square difference between the two range images. The generic range image is modified in the z-direction as well. Initially the control points are moved in groups (e.g., both eyes, one eye, etc.). Later in the process they are moved individually. The generic portrait is warped by the same parameters as the range image, and its color is varied to minimize the mean square difference in color as well. Once the displacement parameters that yield the best geometric and color match have been determined, they are used as features for face recognition.

As an alternative, each of a plurality of example faces can be previously warped to match a generic face image. Then the target face is deformed by a set of displacement parameters that is formed as a weighted sum of the displacement parameters that were developed for each example face. The weighting coefficients in that linear combination are adjusted iteratively so as to minimize the mean square distance between the warped target face and the unaltered generic face. Alternatively, the generic face can be similarly warped so as to match the unaltered target face. In either case, the set of weighting coefficients that minimize the MSE are used as features of the target face for facial recognition. Ideally, the set of example faces would include faces of diverse physical types (e.g., narrow, wide, tall, short, etc.) so that any human face could be well approximated by a linear combination warp as described above.

Geometric Features

There are a number of geometric features that can be extracted from the oriented and cropped target facial model 24. Specifically the following features can be extracted from the polyhedron in 3-space that forms the target facial model 24: curvature measurements computed over a region or a path, moments computed over a region or over the entire face, and frequency domain features (e.g. take Fourier transform and compute features from the Fourier coefficients).

Curvature measurements can be computed directly from the polygon mesh or, preferably, from the range image. A plane that is normal to the surface can be fitted through any two given points on the face. Then the surface defines a curve on that plane. One can calculate the curvature at each point on that curve (e.g., based on derivatives, or as the reciprocal of the radius of the tangent circle). Parameters such as minimum and maximum curvature serve as features. At specified points on the face, one can also compute the minimum and maximum curvature over all orientations of a plane normal to the surface.

Gaussian curvature is the product of the minimum and maximum curvature at a point on the surface, and it indicates the local curvature change. A value of zero implies a locally flat surface, while positive values imply ellipsoidal shape, and negative values imply parabolic shape. The mean curvature is the average curvature over 180 degrees of rotation at the point. These values, computed at key points on the face, are all potentially useful features for face matching.

Features Derived from the Range Image

Either the raw range image, or a processed version of it as described below, can be used to produce facial measurements for identification. The range image (preferably a 501-column by 751-row 8-bit monochrome digital image, with the tip of the nose located at the central [250, 375] pixel position as indicated in FIG. 15) is first cropped to a smaller area that includes, for example, only the 300-by-420-pixel area of the face from the upper lip to the eyebrows and from the left end of the left eye to the right end of the right eye. This cropping is done to reduce the image to cover only that area of the face containing characteristic geometric shape information which is minimally affected by expression, appliances, and facial hair.

The cropped, processed range image is next subsampled by a suitable factor, such as 20, to reduce the number of data points to a manageable number, in this example, 300/20×420/20=360. Preferably the subsampling is preceded by lowpass filtering. The resulting pixel values of the cropped and subsampled processed range image are then reduced to a smaller number of features by principal component analysis (PCA), independent component analysis (ICA), or, preferably, by linear discriminant analysis (LDA). PCA, ICA, and LDA are well-known statistical techniques that are commonly used in pattern recognition to reduce the number of features that must be used for classification. PCA produces statistically independent features, but LDA is preferable because it maximizes class separation. In either case, a prior analysis establishes sets of coefficients that are then used to compute new features that are each a linear combination of the input features. In this example, 17 new features are computed as linear combinations of the 360 pixel values obtained from the cropped, filtered, subsampled range image. Seventeen sets of 360 coefficients result from the LDA, which are used in the weighted summations. The 17 features that result can be used in a minimum-distance classifier, as described herein, to identify the face.

Processing the Range Image

Prior to the computations described in the previous section, it is useful to process the range image using some type of local operation that replaces the raw pixel value with a new value that has been computed from a small neighborhood surrounding that pixel location. When the above process is repeated on the processed range image, additional features result. These can be used in various combinations to improve classifier performance, particularly in cases where the system has a large database of known faces.

For example, the Gaussian curvature of the image is defined, at each point, as:

$$K = \frac{{f}_{xx} {f}_{yy} - {f}_{xy}^{2}}{( 1 + {f}_{x}^{2} + {f}_{y}^{2} )}$$

and the mean curvature is defined as:

$$H = \frac{1}{2} [ \frac{{f}_{xx} ( 1 + {f}_{y}^{2} ) + {f}_{yy} ( 1 + {f}_{x}^{2} ) - 2 {f}_{x} {f}_{y} {f}_{xy}}{\sqrt{1 + {f}_{x}^{2} + {f}_{y}^{2}}} ]$$

$$where$$

$$\begin{matrix}{f}_{x} = \frac{\partial }{\partial x} f ( x , y ) , \\ {f}_{y} = \frac{\partial }{\partial y} f ( x , y ) , \\ {f}_{xx} = \frac{\partial {}^{2}}{\partial {x}^{2}} f ( x , y ) , \\ {f}_{yy} = \frac{\partial {}^{2}}{\partial {y}^{2}} f ( x , y ) , \\ {f}_{xy} = \frac{\partial {}^{2}}{\partial xy} f ( x , y )\end{matrix}$$

are the partial first and second derivatives of the range image. The maximum curvature and minimum curvature are given by:
κ₁=H+\sqrt{H²−K} and κ₂=H−\sqrt{H²−K}
respectively, and these can be combined to produce a shape feature which takes on values between zero and one defined by:

$$S = \frac{1}{2} - \frac{1}{π} {tan}^{- 1} [ \frac{{κ}_{1} + {κ}_{2}}{{κ}_{1} - {κ}_{2}} ]$$

Two other quantities related to the surface properties of face are the metric determinant, g=\sqrt{1+ƒₓ²+ƒ_{y}^{2,}} and the quadratic variation Q=ƒₓₓ²+2ƒ_{xy}²+ƒ_{yy}², both of which are summed over a local neighborhood (patch) at each point in the image.

The mean value of each of hue, saturation, and intensity, as well as their standard deviation or variance can be computed from the color portrait image, which can then be processed as described above for the range image (i.e., crop, subsample, and LDA). Other local operations are also possible to perform on the range image or portrait prior to feature extraction as described above.

Moment Features

Moments can be computed over the entire face or over a region. Moments are computed as weighted integrals (or summations) of a function. They are widely used in probability and statistics, and, when applied to an image, can produce useful measures. Conventional 2-D image processing techniques can be used to compute moments, as well as many other features from the range image. For example, a Gabor filter bank can be applied to range images and the high-frequency coefficients of the Gabor filter bank can be evaluated as features.

Wavelet-Based Features

A novel set of features that can be used for 3D face recognition is based on wavelet analysis, which can be a dominant method in 3D surface modeling and analysis. The important properties that such algorithms have are as follows:
Multi-scale manipulability to overcome the shift-variance of orthonormal wavelet bases.
Spatial localization to enable finer feature matching.
Spectral localization to enhance noise resilience.
Moment properties that improve recognition accuracy and speed. A critical step of this approach is to find the wavelet bases that best satisfy these properties. To do this, a fudamental new method based on wavelet-based progressive meshes can be employed. This method has been applied to various problems related to visualization and compression, but has seen limited application in face recognition and related areas. This technique is superior to existing 3D face recognition techniques in dealing with data loss due to occlusion by facial hair, eyeglasses, etc.

e. Feature selection

The “features” are the actual characteristics of the face that are measured and used by the system to identify that face. Since hundreds of features can be measured, the goal of feature selection is to identify an optimal subset of the features that work in combination to provide the lowest combination of FAR and MR for a particular security application. Each subset of features produces a Receiver Operating Characteristic (ROC) curve, which is a plot of FAR vs. MR as one of the decision parameters (a threshold) is varied. Each feature subset tested during the development process receives a score based on the area under the relevant portion of the ROC curve. Alternatively, the score can be taken as the MR that corresponds to a particular fixed FAR, to the FAR that corresponds to a particular fixed MR, or to the value of MR and FAR at the point on the ROC curve where they are equal. In any case the highest scoring few subsets are incorporated into a final system design, and the most appropriate one can be selected by the operator to suit various screening situations.

3. Image Matching

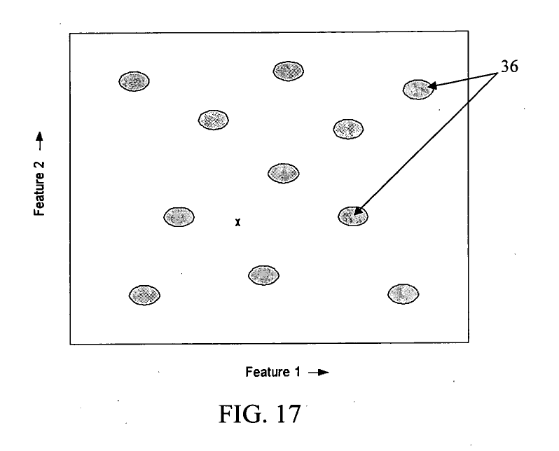

For image matching, an approach based on classical pattern recognition theory is preferably used. Conventional facial recognition techniques typically use some form of face matching, using a variation of template matching, to compute a match score between pairs of faces. While this technique can be used on the above describe measurement results, it is preferred to utilize the concept of recognizing faces by their location in a multi-dimensional feature space. Each individual in the database corresponds to a small (e.g., hyperrectangular, or hyperellipsoidal) region in a multidimensional feature space that is defined by the measurements used. For example, FIG. 17 illustrates a 2-dimensional feature space, with each ellipsoid 36 corresponding to a particular individual in the database. An unknown face is shown as mapping to a position “x” in the feature space, that position defined by its two measurement values. Since the position “x” does not fall inside one of the ellipsoids, the unknown face does not match anyone in the database. The finite volume of each ellipsoid accounts for variations in pose, expression, etc. and provides the equivalent of having multiple images of the person's face stored in the database. The volume of the region (e.g., the radius of the ellipsoid) is the primary parameter that controls the tradeoff of MR and FAR that is expressed by the ROC curve. Increasing the radius (threshold) has the effect of reducing the MR while increasing the FAR, and conversely. This allows the error rate tradeoff to be optimized for each particular face recognition application.

If there are M dimensions (features) being mapped in the feature space, the M- element measurement vector from the unknown face specifies a particular point in M-dimensional feature space. If that point, corresponding to the unknown face, falls inside one of the ellipsoids, it is identified as the individual corresponding to that ellipsoid. If it falls between the ellipsoids, it is classified as “unknown,” or “not in the database.” The basic size of the ellipsoids is based on experimentally determined feature variance, and the features are selected to minimize ellipsoid size. The size of the ellipsoids can be varied to trade off FAR and MR as desired, since larger ellipsoids reduce MR at the expense of FAR, and vice versa. Varying the size of the ellipsoids trades off FAR and MR so as to sweep out an ROC curve. Further, the number of features used sets the dimensionality of the feature space (two in this example). Using more features (higher dimension) creates more empty space between ellipsoids, thereby reducing the probability of a false alarm. Ideally, a larger database would require a larger number of features. In any case, (1) the feature subset is selected, (2) the ROC curve is determined by experiment on pre-classified images, and (3) the specific operating point on the ROC curve is selected for best performance in a particular application.

For 3-D matching, the measurement vector from the unknown face is matched against a database of measurements taken from images in the 3-D database. The distance in feature space from the unknown point (“X” in FIG. 16) to the center of each of the ellipsoids is calculated. If the minimum distance falls within the radius of one ellipsoid, the target face is assigned that identity. If not, the target face is labeled as “unknown.” Although overlap of ellipsoids is unlikely in a well-designed system, if X falls inside two or more ellipsoids, it is assigned to the one having the closest center. For 2-D matching, the measurement vector from the unknown face is similarly matched against a database of measurements taken from images in the 2-D database. The distance calculation can be the simple Euclidean distance in feature space, or preferably, the Mahalanobis distance that is commonly used in the field of statistical pattern recognition. There are other well-known distance metrics that can be used as well.

In a normal pattern recognition problem, one strives to keep the dimensionality of the feature space (i.e., the number of features) as low as possible, consistent with adequate performance. In the face matching problem, however, the situation is different. As the number of individuals in the database grows, the amount of empty space between ellipsoids decreases, making a true negative assignment less likely. Indeed, a low-dimensional feature space could “fill up” with ellipsoids, leaving little chance that anyone would ever be unflagged as a hit. Thus there is an optimal dimensionality of the feature space, and it depends on the number of entries in the database. Optimally, the software implementing the present invention is configurable for selecting different numbers of features to suit different database sizes. As the database grows, the number of features can be increased to remain optimized.

Preferably a divide-and-conquer approach is used for database searching to minimize search time. Initially a few very robust features are used to eliminate some large portion (say, 90%) of the database. Then a slightly larger set of features eliminates 90% of the remaining faces. Finally the full feature set is used on the remaining 1% of the database. The actual number of such iterations can be determined experimentally. However, the distance calculation required for face matching is simple and requires very little CPU time, compared to the other steps in the process, so a more straightforward database searching technique may be adequate.

Once a match is identified, the unknown face and the identified individual from the database can displayed side-by-side (e.g. side by side display of color portrait images of each), where an operator can quickly verify the match and take the appropriate action.

Face Matching

In the face recognition algorithms, a classical statistical pattern recognition approach to the decision making process is preferred. In particular, the algorithmic structure of a

Bayes maximum likelihood classifier assuming multivariate normal statistics is used. This technique is well known in the pattern recognition art.

A K-class, M-feature Bayes classifier is constructed, where K is the number of persons enrolled in the database, and M is the number of features that are measured on each face. Normally a Bayes classifier will assign every object to the most likely one of the K pre-established classes, no matter how unlikely that assignment may be. Here, however, a rejection criterion, based on a confidence factor, is imposed so that low-likelihood matches are rejected, and no match is asserted by the system. For one-to-many security screening applications, K is the number of watchlist suspects in the data base. For one-to-few access control applications, K is the number of persons (e.g. employees) in the data base. For one-to-one matching K=1, and a one-class classifier with a rejection criterion is used. Thus rejection due to low confidence can be considered to be a separate class.

The accuracy of an M-class pattern recognition system can be specified conveniently by its Mby Mconfusion matrix, where the i,j^{th} element is the probability that an object that actually belongs to class i will be assigned to class j. The diagonal elements (i=j) are the probabilities of correct classification, while the off-diagonal elements are the probabilities of the various misassignment errors that the system can make.

The classical formulation of the Minimum Bayes Risk classifier allows the designer to specify (1) the prior probability of each class, (2) a cost matrix that assigns a cost value to each element of the confusion matrix, and (3) the multidimensional probability density function (pdf) of each class. For the face recognition application we assume (1) equal prior probabilities for each class, (2) equal costs for all errors, and (3) multivariate normal pdfs. In this case the Minimum Bayes Risk classifier simplifies to what is known as a minimum distance classifier.

A multivariate normal pdf is specified by its M-element mean vector and its M by M covariance matrix. The mean vector for each class specifies what is unique about that person's face. The covariance matrix specifies (on the diagonal) the within-class variance of each of the features and (off the diagonal) their covariances, which result from the correlations between pairs of features. In a normal Bayes classifier each class has its own covariance matrix. The enrollment process in face recognition, however, normally does not afford enough samples to permit estimation of the covariance matrix for each individual.

Accordingly, it is assumed that one covariance matrix describes the variances and correlations of the features for every face, and a single covariance matrix, either assumed, or formed by pooling many covariance matrices together, is therefore used for all classes.

Since lighting and pose are controlled in the image acquisition procedure, expression and accessories will be the main contributors to feature variance within-class. Preferably linear discriminant analysis (LDA) or principal component analysis (PCA) is used to reduce a rather large number of “raw” features that are measured on each face to a smaller set of “derived” features that are used in the classification process. The techniques of LDA and PCA are well known in the pattern recognition art. They are described, for example, in [Q. Wu, Z. Liu, T. Chen, Z. Xiong, K. R. Castleman, “Subspace-Based Prototyping and Classification of Chromosome Images,” IEEE Trans. Image Processing, 14(9):1277-87; R. Duda, P. Hart, D. Stork, Pattern Classification, Wiley, New York, 2001; R. Fisher, “The Statistical Utilization of Multiple Measurements,” Eugen 8:376-86. 1938]. They define a set of derived features, each of which is formed as a linear combination of a the raw features. The derived features that result from LDA or PCA will generally be uncorrelated with one another or express low correlation values. For this reason it is expected that most or all of the off-diagonal elements of the covariance matrix will be zero, or small enough to be ignored. Since the covariance matrix must be inverted for the distance computation (described below), having zeroes in the off-diagonal elements makes the matrix inversion calculation both faster and numerically more stable.

The face matching and admit/deny decisions are preferably made on the basis of Mahalanobis (variance-normalized) distance in feature space. The Mahalanobis distance between two points in M-dimensional space is:
d(X,Y)=(X−Y)^{T}S¹(X−Y)
where X and Y are M-element vectors that specify the locations of the two points in the feature space, and S is an M by M covariance matrix. Normally, in a Bayes classifier, X is the mean of one of the classes, S is the covariance matrix for that class, and Y is the feature vector of the unknown object being classified. The object would be assigned to the class that produces the smallest distance. Preferably, for face recognition, a confidence criterion is imposed whereby no match is reported if the minimum distance exceeds a preset threshold.

For one-to-few access control applications, the closest (minimum distance) match in the database is determined, and access is denied if that distance exceeds a threshold. For one-to-one matching (the one-class case) access is denied if the distance between the biometrics (feature vectors) of the current and claimed identities exceeds a preset threshold value. For security screening applications, an alert is generated if any entry in the data base produces a Mahalanobis distance that is less than a preset threshold value. There are other distance metrics that are well-known in the pattern recognition art that can be substituted for the Mahalanobis distance.

Access Control and Accuracy

The function of an access control system is to admit authorized individuals into a secure space and deny access to unauthorized persons. The primary performance specifications for an access control system are its False Accept Rate (FAR) and its False Reject Rate (FRR). The FAR is the probability that an unauthorized individual will be admitted (i.e. a false positive result), and the FRR is the probability that an authorized individual will be denied entry (i.e. a false negative result), both based on a single trial. These two error rates can be traded off against one another by adjusting parameters in the recognition software. The plot of FAR vs. FRR demonstrates this tradeoff and is the Receiver Operating Characteristic (ROC) curve, as discussed above for screening applications.

There are two scenarios under which an access control system can operate. For “one-to-one” matching, the subject asserts a particular identity, usually with an ID card, and the system compares his current biometric (i.e., feature vector) to that of the claimed identity. If the match is close enough, access is granted. For “one-to-few” matching, the subject does not claim an identity. The system compares his/her current biometric against all of those stored in its database, and if any one is close enough, access is granted. By varying the threshold of what is “close enough” one can trade off FAR and FRR against each other to sweep out an ROC curve.

One-to-one matching is simply a special case of one-to-few, namely where the database contains only one enrollee. For one-to-few matching, one is left with the question, “How many is a few?” Thus there is a continuum here. One would expect face recognition

accuracy to be highest for one-to-one matching and to degrade slowly as database size increases in the one-to-few case. Thus FAR and FRR are properly functions of database enrollment size.

It is to be understood that the present invention is not limited to the embodiment(s) described above and illustrated herein, but encompasses any and all variations falling within the scope of the appended claims. For example, computers 16 and 18 can be subsystems (software and/or hardware) for image acquisition, processing and matching functions as part of a single computing system. Alternately, the various tasks described above with respect to image acquisition, processing and/or matching can be performed by subsystems that constitute hardware and/or software distributed within a single computer or electronic system, a distributed computer or electronic system, a series of networked computer or electronic systems, a series of stand alone computer or electronic systems, or any combination thereof. Further, as is apparent from the claims and specification, all method steps need not necessarily be performed in the exact order illustrated or claimed, but rather in any order that functions to acquire, process and match image information as described above. In addition, for a less complex system, color camera(s) 14 can be omitted, and facial recognition can be carried out using just the geometry of the target face (i.e. the normalized facial model only contains geometric information and not color/texture information).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

What is claimed is:

1. A facial recognition system for analyzing images of a target face, comprising:
a facial model subsystem configured to create a three-dimensional facial model from a plurality of two-dimensional images of a target face;
a normalization subsystem configured to move the three-dimensional facial model to a predetermined pose orientation to result in a normalized three-dimensional facial model;
a measurement subsystem configured to extract measurements from the normalized three-dimensional facial model; and
a matching subsystem configured to compare the extracted measurements to other facial measurements stored in a data base.

2. The system of claim 1, wherein the plurality of two-dimensional images includes at least two images of the target face from at least two different angles relative to the target face.

3. The system of claim 1, further comprising:
a first camera system that includes:
a projector configured to illuminate the target face with a known pattern, and
at least two cameras configured to capture at least two of the two-dimensional images from at least two different angles relative to the illuminated target face.

4. The system of claim 3, further comprising:
a second camera system that includes:
at least one camera configured to capture at least one of the two-dimensional images which is a color image of the target face.

5. The system of claim 1, wherein the three-dimensional facial model comprises a polyhedral mesh that represents a geometric shape of the target face of the two-dimensional images.

6. The system of claim 5, wherein the three-dimensional facial model further represents color and/or texture of the target face of the two-dimensional images.

7. The system of claim 1, wherein the predetermined pose orientation is defined by a generic facial model having a predetermined orientation.

8. The system of claim 7, wherein the normalization subsystem is configured to perform the moving of the three-dimensional facial model by minimizing a pose orientation difference between the three-dimensional facial model and the generic facial model.

9. The system of claim 7, wherein the normalization subsystem is configured to perform the moving of the three-dimensional facial model by minimizing a mean square difference between orientations of the three-dimensional facial model and the generic facial model.

10. The system of claim 9, wherein the normalization subsystem is configured to minimize the mean square difference by comparing distances in directions orthogonal to surfaces of the three-dimensional facial model or the generic facial model.

11. The system of claim 1, further comprising:
a range subsystem configured to create range image data from the normalized three dimensional facial model;
wherein the measurement subsystem is configured to extract measurements from the normalized three-dimensional facial model by extracting measurements from the range image data.

12. The system of claim 11, further comprising:
a color subsystem configured to create color image data from the normalized three dimensional facial model;
wherein the measurement subsystem is configured to extract measurements from the normalized three-dimensional facial model by extracting measurements from the color image data.

13. The system of claim 11, wherein the range image data includes distances Z between the normalized three-dimensional facial model and an X-Y plane.

14. The system of claim 12, wherein the color image data includes red, green, blue color data of the normalized three-dimensional facial model.

15. The system of claim 1, wherein the extracted measurements include at least one of facial landmark positions, color characteristics, and geometric shape.

16. The system of claim 1, wherein the measurement subsystem is configured to extract the measurements by a comparison of the normalized three-dimensional facial model with a generic facial model.

17. The system of claim 1, wherein the measurement subsystem is configured to extract the measurements by deforming a generic facial model to match the normalized three-dimensional facial model.

18. The system of claim 17, wherein the measurement subsystem is configured to deform the generic facial model by applying control points of a control grid to facial features of the normalized three-dimensional facial model and by moving the control points.

19. The system of claim 1, wherein the measurement subsystem is configured to extract the measurements by measuring geometric features of the normalized three-dimensional facial model.

20. The system of claim 1, wherein the matching subsystem is configured to compare the extracted measurements to the other facial measurements stored in a data base by:
creating a multi-dimensional feature space;
mapping the other facial measurements stored in the data base to the multi-dimensional feature space as hyper-regions;
mapping the extracted measurements from the normalized three-dimensional facial model to a point in the multi-dimensional feature space; and
determining any overlap between the point and the hyper-regions.

21. A facial recognition method for analyzing images of a target face, comprising:
creating a three-dimensional facial model from a plurality of two-dimensional images of a target face;
moving the three-dimensional facial model to a predetermined pose orientation to result in a normalized three-dimensional facial model;
extracting measurements from the normalized three-dimensional facial model; and
comparing the extracted measurements to other facial measurements stored in a data base.

22. The method of claim 21, wherein the plurality of two-dimensional images includes at least two images of the target face from at least two different angles relative to the target face.

23. The method of claim 21, further comprising:
creating the plurality of two-dimensional images of the target face, wherein the creating comprises:
illuminating the target face with a known pattern, and
capturing at least two of the two-dimensional images from at least two different angles relative to the illuminated target face.

24. The method of claim 23, wherein the creating further comprises:
capturing at least one of the two-dimensional images which is a color image of the target face.

25. The method of claim 23, wherein the three-dimensional facial model comprises a polyhedral mesh that represents a geometric shape of the target face of the two-dimensional images.

26. The method of claim 25, wherein the three-dimensional facial model further represents color and/or texture of the target face of the two-dimensional images.

27. The method of claim 21, wherein the moving of the three-dimensional facial model to the predetermined pose comprises minimizing a pose orientation difference between the three-dimensional facial model and a generic facial model having a predetermined orientation.

28. The method of claim 27, wherein the minimizing of the pose orientation difference comprises minimizing a mean square difference between orientations of the three-dimensional facial model and the generic facial model.

29. The method of claim 28, wherein the minimizing of the mean square difference comprises comparing distances in directions orthogonal to surfaces of the three-dimensional facial model or the generic facial model.

30. The method of claim 21, wherein the extracting of the measurements from the normalized three-dimensional facial model comprises:
creating range image data from the normalized three dimensional facial model; and
extracting measurements from the range image data.

31. The method of claim 30, wherein the extracting of the measurements from the normalized three-dimensional facial model further comprises:
creating color image data from the normalized three dimensional facial model; and
extracting measurements from the color image data.

32. The method of claim 30, wherein the range image data includes distances Z between the normalized three-dimensional facial model and an X-Y plane.

33. The method of claim 31, wherein the color image data includes red, green, blue color data of the normalized three-dimensional facial model.

34. The method of claim 21, wherein the extracted measurements include at least one of facial landmark positions, color characteristics, and geometric shape.

35. The method of claim 21, wherein the extracting of the measurements comprises comparing the normalized three-dimensional facial model with a generic facial model.

36. The method of claim 21, wherein the extracting of the measurements comprises deforming a generic facial model to match the normalized three-dimensional facial model.

37. The method of claim 36, wherein the deforming of the generic facial model comprises:
applying control points of a control grid to facial features of the normalized three-dimensional facial model; and
moving the control points.

38. The method of claim 21, wherein the extracting of the measurements comprises measuring geometric features of the normalized three-dimensional facial model.

39. The method of claim 38, wherein the measuring of the geometric features of the normalized three-dimensional facial model comprises:
creating range image data from the normalized three dimensional facial model; and
measuring geometric features of the range image data.

40. The method of claim 21, wherein the comparing of the extracted measurements to the other facial measurements comprises:
creating a multi-dimensional feature space;
mapping the other facial measurements stored in the data base to the multi-dimensional feature space as hyper-regions;
mapping the extracted measurements from the normalized three-dimensional facial model to a point in the multi-dimensional feature space; and
determining any overlap between the point and the hyper-regions.
